(19) United States
(12) Patent Application Publication
(10) Pub. No.: US 2026/0099760 A1
(43) Pub. Date: Apr. 9, 2026

(54) GENERATING AND TRAINING MACHINE LEARNING MODELS FOR CLASSIFYING RETAIL SYSTEM USER ACCOUNTS

(71) Applicant: Target Brands, Inc., Minneapolis, MN (US)

(72) Inventors: Amartya Basu, Minneapolis, MN (US); Omnarayan Kedarlal Gupta, Minneapolis, MN (US); Evan Gaustad, Minneapolis, MN (US)

(21) Appl. No.: 18/908,292

(22) Filed: Oct. 7, 2024

(51) Int. Cl. G06N 20/00; G06F 18/241

(52) U.S. Cl. CPC G06N 20/00; G06F 18/241

(57) ABSTRACT

In some implementations, a method performed by data processing apparatuses includes receiving multiple predetermined user account labels associated with user accounts for a retail system. Each user account is associated with user behavior data of a data source for the retail system, and is indicative of a reseller account label. The method further includes selecting a training data set including user behavior data, augmenting the training data set with additional user behavior data from the data source, and training a classification model with the training data set in response to augmenting the training data. The classification model is trained to classify a first user account for the retail system with a reseller account label or a non-reseller account label based on user behavior data of the data source associated with the first user account.

### TECHNICAL FIELD

This specification generally relates to techniques for classifying retail system user accounts, particularly techniques for generating and training machine learning models for classifying retail system user accounts.

### BACKGROUND

Retails stores may establish user accounts for customers to use when making purchases online or in physical stores. Typically, user accounts may be secured using passwords or other authentication credentials. Stolen credentials for user accounts may be used for retail fraud or other malicious activities. User accounts may be used by typical retail customers as well as by resellers, who are legitimate customers who purchase items for resale. Although resellers are legitimate users, certain reseller activities may appear to be similar to activities commonly performed by malicious actors. Currently, retailers may manually label accounts while performing manual review of rule-based fraud detection.

### SUMMARY

This document generally describes computer systems, processes, program products, and devices for training machine learning models to classify user accounts for a retail system as reseller accounts or non-reseller accounts, for example to detect malicious activity. Customers or other users of a retail system may establish user accounts with the retail system. Legitimate users of the retail system may include resellers and non-resellers. The technology described in this document involves an account labeling system that, given a relatively small number of labeled user accounts associated with known resellers, trains one or more machine learning classifiers to automatically classify user accounts as resellers or non-resellers based on user context, including user behavior data. After training, the classifier may be used to label additional user accounts as reseller or non-reseller accounts, which may be used for detection of malicious activity, such as account takeovers or other unauthorized account access.

In some implementations, a method performed by data processing apparatuses includes receiving a plurality of predetermined user account labels, wherein each user account label is associated with a user account of a plurality of user accounts for a retail system, wherein each user account is associated with user behavior data of a data source for the retail system, and wherein each of the user account labels is indicative of a reseller account label; selecting a training data set including user behavior data from the data source associated with the predetermined user account labels; augmenting the training data set with additional user behavior data from the data source, wherein the additional user behavior data is associated with one or more additional user accounts for the retail system, and wherein the additional user behavior data is associated with a reseller account label or a non-reseller account label; and training a classification model with the training data set in response to augmenting the training data, wherein the classification model is trained to classify a first user account for the retail system with a reseller account label or a non-reseller account label based on user behavior data of the data source associated with the first user account.

Other implementations of this aspect include corresponding computer systems, and include corresponding apparatus and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

These and other implementations can include any, all, or none of the following features. Selecting the training data set may include selecting the user behavior data from a plurality of data sources for the retail system; and training the classification model may include training a plurality of classification models, wherein each classification model of the plurality of classification models is associated with a data source of the plurality of data sources. The plurality of data sources may include a user profile data source, an order history data source, and an aggregated item data source. The user behavior data may include user name, user email address, account open date, count of associated user devices, count of shipping addresses, count of payment cards, order history, or item combination. Augmenting the training data set may include identifying a cluster of user accounts for the retail system with an unsupervised clustering algorithm based on the user behavior data, wherein the cluster of user accounts includes the user accounts associated with the predetermined user account labels. Training the classification model may include training the classification model with a supervised machine learning algorithm. The method may further include classifying, in response to training the classification model, the first user account with a reseller account label or a non-reseller account label using the classification model based on the user behavior data of the data source associated with the first user account. The method may further include receiving a request for classification of the first user account from a client system; and sending a response including a classification of the first user account to the client system in response to receiving the request and in response to classifying the first user account, wherein the classification comprises the reseller account label or the non-reseller account label. Classifying the first user account may further include classifying the first user account with a plurality of classification models, wherein each classification model is associated with a data source of a plurality of data sources for the retail system; and selecting the classification based on a majority of the plurality of classification models.

The method may further include performing fraud detection based on the classification of the first user account.

The systems, devices, program products, and processes described throughout this document can, in some instances, provide one or more of the following advantages. In particular, the techniques described herein may provide improved user account classification performance and accuracy as compared to previous techniques, which required manual labeling of accounts by an analyst or other specialist. Additionally, the technologies described herein may be used to improve automated fraud detection or other automated malicious behavior detection by providing improved input features that provide improved detection analysis and efficiency by reducing noisy input associated with user behavior of reseller accounts.

Other features, aspects and potential advantages will be apparent from the accompanying description and figures.

### DESCRIPTION OF DRAWINGS

FIG. 1 depicts an example system for classifying user accounts for a retail system.

FIG. 2 is a flow diagram of an example technique for training a classifier for classifying user accounts as reseller or non-reseller accounts.

FIG. 3 is a flow diagram of an example technique for programmatically providing a classification of a user account to a classification consumer using a trained classifier.

FIG. 4 is a flow diagram of an example technique for augmenting a training data set for training the classifier of FIGS. 2 and 3.

FIG. 5 is a schematic diagram that shows an example of a computing device and a mobile computing device.

Like reference symbols in the various drawings indicate like elements.

### DETAILED DESCRIPTION

This document describes technology for training machine learning models for classifying user accounts for a retail system as reseller accounts or non-reseller accounts. This classification as a reseller account or non-reseller account may be used for multiple purposes, including as an additional input to identify malicious account takeover activity, fraudulent activity, or other malicious activity. Briefly, an account labeling system receives a set of key account labels that identify user accounts that are known to be reseller accounts. Based on those key account labels, the account labeling system creates a training data set and then augments the training data set using additional user account data for the retail system. The account labeling system trains one or more machine learning models to classify user accounts as reseller accounts or non-reseller accounts based on the augmented training data set. After training, the account labeling system may classify user accounts with the trained model, and may provide the classification to one or more client systems via an application programming interface (API) or other interface.

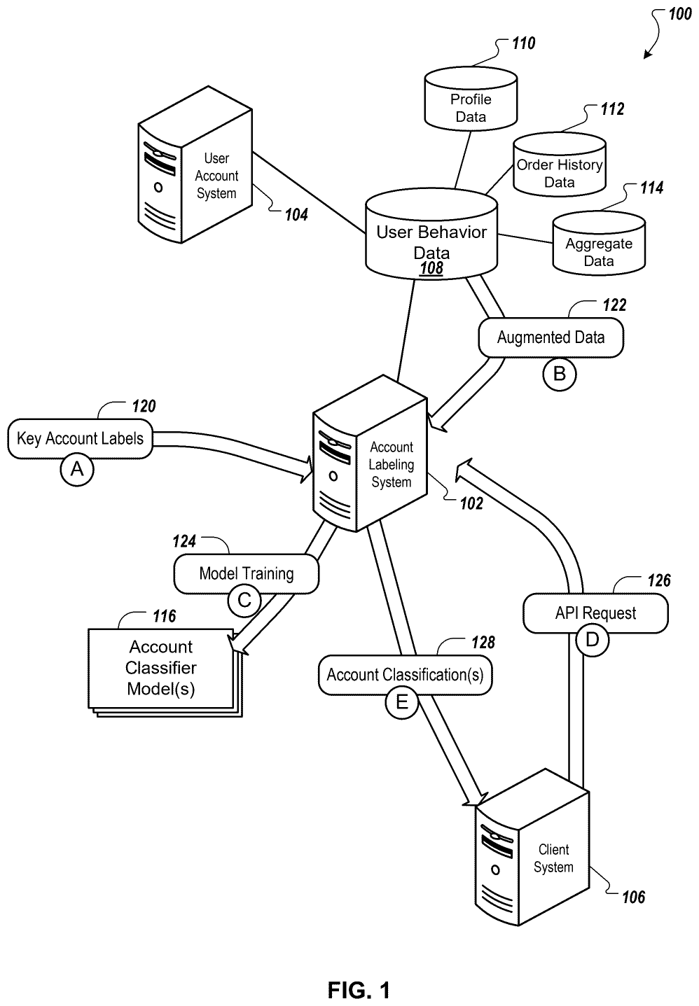

FIG. 1 depicts an example system 100 for generating and training machine learning models for classifying user accounts, as represented in example stages (A) to (E). Stages (A) to (E) may occur in the illustrated sequence, or they may occur in a sequence that is different than in the illustrated sequence, and/or two or more stages (A) to (E) may be concurrent. In some examples, one or more stages (A) to (E) may be repeated multiple times when retraining and/or servicing multiple API requests.

The system 100 can include an account labeling system 102, a user account system 104, and one or more client systems 106. Each of the systems 102, 104, 106, for example, can include one or more computing servers and/or workstations and one or more data sources. In some examples, multiple of each system 102, 104, 106 can be combined into a single system, and/or any of the systems can be partitioned into two or more separate systems. In some examples, the computing servers can include various forms of servers, including but not limited to network servers, web servers, application servers, or other suitable computing servers. In some examples, the data sources can include databases, file systems, and/or cached data sources. The computing servers, for example, can access data from the data sources, can execute software that processes the accessed data, and can provide information based on the accessed/processed data to client devices that can be operated by users. Communication between the computing servers, the data sources, and the client devices, for example, can occur over one or more communication networks, including a LAN (local area network), a WAN (wide area network), and/or the Internet.

As shown, the system 100 includes user behavior data 108 which may be associated with the user account system 104. The user behavior data 108 includes data managed or generated by and/or otherwise associated with user accounts for a retail system. The retail system may include one or more retail stores, an e-commerce platform, or any combination of physical and online retail. Each user account may be associated with a customer or other user of the retail system. The user behavior data 108 is indicative of user profile information associate with a user account, order history, payment information, and other data related to activities performed by the user of the retail system.

As shown, the user behavior data 108 may include multiple data sources, including profile data 110, order history data 112, and aggregate data 114. The profile data 110 may include data related to the user account itself, such as a user name, a user email address, an account open date, a count of user devices used to access the account, or other user profile data. The order history data 112 may include data related to one or more orders or other purchases made with a user account, including the particular item(s) ordered, order date, shipping method or shipping address, a count of shipping addresses, a count of payment cards, whether a store credit card is used, or other order history data. The aggregate data 114 may include user behavior data that is synthesized, combined, derived, or otherwise generated from other user behavior data. For example, in some embodiments, the aggregate data 114 may include an indication that a user has purchased a particular combination of items, which may be identified as being indicative of malicious behavior. The aggregate data 114 may be provided, for example, by a security team, engineering team, or other security analyst for the retail system. In some embodiments, the aggregate data 114 may be generated by one or more automated rules, which may be provided by the security team of the retail system.

During stage (A), a set of key account labels 120 is provided to the account labeling system 102. The key account labels 120 identify particular user accounts from the user account system 104 that are known to be reseller accounts with high confidence. The key account labels 120 may be generated, for example, by a security team or other domain expert associated with the retail system. The key account labels 120 may be used to generate training data, which may include user behavior data 108 that is associated with the known reseller accounts, as well as the associated reseller account labels.

During stage (B), the account labeling system 102 augments the training data with augmented data 122, which includes additional user behavior data 108 and associated labels. For example, the account labeling system 102 may use a clustering algorithm or other non-supervised algorithm to identify additional user accounts similar to (or different from) the user accounts associated with the key account labels 120. The augmented data 122 may be labeled with corresponding reseller account labels or non-reseller account labels.

During stage (C), the account labeling system 102 performs model training 124 with an account classifier model 116 based on the augmented training data. The account labeling system 102 may train the account classifier model 116 using an appropriate supervised machine learning algorithm with the reseller account labels and non-reseller account labels that are determined as described above. The account classifier model 116 may be embodied as any machine learning classifier model, including gradient-boosted trees, an artificial neural network, a convolutional neural network, a support vector machine, and/or other classifier. Although illustrated as a single account classifier model 116, it should be understood that in some embodiments, the account labeling system 102 may train multiple account classifier models 116. Each account classifier model 116 may be trained with user behavior data 108 from a particular data source. For example, in an embodiment the account label system 102 may train three models, including one account classifier model 116 for each of the respective profile data 110, order history data 112, and aggregate data 114.

During stage (D), the account labeling system 102 receives an application programming interface (API) request 126 from one or more client systems 106. The API request may identify a particular user account of the user account system 104 for classification. The client system 106 may generate the API request 126 for example as part of a security analysis workflow, during an automated process, or other process. The account labeling system 102 collects user behavior data 108 corresponding to the requested user account and uses the trained account classifier model 116 to classify the user account as a reseller account or a non-reseller account. During stage (E), the account labeling system 102 sends a response to the client system 106 including one or more account classifications 128 generated in response to the API request 126. The client system 106 may use the account classifications 128, for example, to identify fraud or malicious behavior or to otherwise perform a security response.

Accordingly, the system 100 is capable of automatically and accurately classifying user accounts as reseller accounts or non-reseller accounts based on user behavior data 108. These automated and accurate classifications may be used to improve detection of malicious activity, including account takeover fraud. For example, many behaviors performed by malicious actors after gaining unauthorized access to a user account may be similar to ordinary behavior of reseller accounts, such as using multiple devices to access the account, purchasing large numbers of items, or purchasing particular high-demand items. Automated, accurate classification of accounts as reseller accounts or non-reseller accounts may thus provide an additional feature to differentiate fraudulent or otherwise malicious activity from legitimate activity, which may enable or improve malicious activity detection and/or prevention. For large retailers with many millions of user accounts, this automated classification may reduce noise in input data and improve classification efficiency and accuracy. For example, reseller accounts may be noisy in that user behavior associated with reseller accounts may be similar to certain malicious behaviors, which leads to false positives and requires manual review for previous systems. Thus, the system 100 may automate fraud detection and analysis that previously required manual review by an investigator of rule-based potential fraud detection.

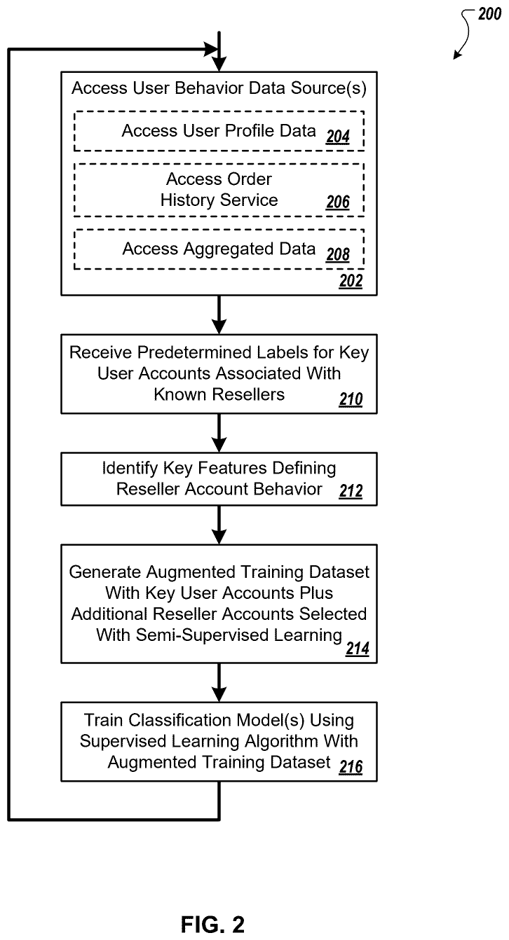

Referring now to FIG. 2, a flow diagram of an example method 200 is shown for training a classifier for classifying user accounts as reseller or non-reseller accounts. In the present example, the method 200 can be performed by components of the system 100 such as the account labeling system 102, and will be described with reference to FIG. 1. However, other systems may be used to perform the same or a similar process.

At 202, the account labeling system 102 accesses one or more user behavior data sources 108. The user behavior data sources 108 may be provided by one or more other systems including the user account system 104 or other components associated with a retail system. As described above, the user behavior data 108 includes data associated with user accounts for a retail system. The user behavior data 108 may be stored in or otherwise accessed via one or more data sources. The data sources may be keyed or otherwise indexed using a user identifier or other identifier associated with the user accounts for the retail system, which allows user behavior data to be associated to particular user accounts. Accordingly, the user behavior data 108 provides context data for the users of the retail system.

At 204, the account labeling system 102 may access the user profile data 110. As described above, the user profile data may include, for example, data related to the user account itself, such as a user name, a user email address, an account open date, a count of user devices used to access the account, or other user profile data. As described above, the order history data may include data related to one or more orders or other purchases made with a user account, including the particular item(s) ordered, order date, shipping method or shipping address, a count of shipping addresses, a count of payment cards, whether a store credit card is used, or other order history data. At 206, the account labeling system 102 may access the order history data 112. At 208, the account labeling system 102 may access the aggregate data 114. As described above, the aggregate data may include user behavior data that is synthesized, combined, derived, or otherwise generated from other user behavior data. The various data sources may be available for different time periods and/or at different schedules. For example, certain data (e.g., order data) may be available in real time or near real time, and other data (e.g., aggregate data) may be generated in batches and available after some delay (e.g., a day later). Accordingly, the account labeling system 102 may access each data source based on data availability.

At 210, the account labeling system 102 receives predetermined labels 120 for one or more key user accounts associated with known resellers. As described above, a reseller is a legitimate customer or other user who purchases items from the retail system for resale. Each of the predetermined labels 120 is associated with a particular user account, which may be maintained by the user account system 104. Each of the predetermined labels 120 is associated with high confidence with a reseller account. For example, the predetermined labels 120 may be generated or otherwise provided by a security analyst or other domain expert. The predetermined labels 120 may represent a relatively small proportion of the total user accounts and/or total reseller user accounts associated with the retail system. For example, in an embodiment with millions of user accounts (or hundreds of millions of user accounts), the predetermined labels 120 may identify 100-200 key user accounts.

At 212, the account labeling system 102 identifies one or more key features from the user behavior data 108 that are associated with known resellers such as the predetermined key user accounts. The identified key features may include account data, metadata, behavior data, or other data features that can be used to distinguish reseller accounts from other user accounts. For example, identified features may include in-store versus online transactions, payment tenders (e.g., gift card versus payment card, store card, employee discount, etc.), item affinity, profile data (e.g., account age, email address, or other account metadata), device identifier data, shipping address data, rate limit violations, and/or login behavior. The key features may be updated or otherwise modified based on observed user behavior. For example, it has been observed that reseller accounts typically specialize in selling certain product categories. Accordingly, an item affinity feature may be determined by categorized purchased items by department, product category, or other product characteristics, and those accounts with a larger number of purchases for a smaller number of departments or other product category may be identified as reseller accounts. In an illustrative example, a measure of item affinity may be represented as a vector with each element representing the number of products purchased for each department or other product category. Continuing that example, reseller accounts may have item affinity vectors that are more sparse than non-reseller accounts. As another example, it has been observed that reseller accounts may use multiple user accounts with a single physical device, which may be determined using a device identifier, a session identifier, a web browser cookie, or another identifying feature. As another example, it has been observed that reseller accounts may use a relatively larger number of shipping addresses as compared to non-reseller accounts. As still another example, it has been observed that reseller accounts may perform purchases or other functions at higher rates than non-reseller accounts. As yet another example, reseller accounts may exhibit particular login patterns, including certain rates of credential failure (e.g., wrong password, etc.), rates of login velocity including geographic login velocity (e.g., successive logins from geographically dispersed locations), and other login features. Of course, other features may be identified in other embodiments.

At 214, the account labeling system 102 generates an augmented training data set that includes data based user accounts associated with the predetermined labels 120, as well as additional user account data. For example, the training data set may initially include user behavior data 108 associated with the key user accounts identified by the predetermined labels 120. Continuing that example, the account labeling system 102 may select user behavior data 108 associated with the key user accounts from one or more data sources, including the user profile data 110, the order history data 112, and/or the aggregate data 114. The training data set also includes labels that may be used for training with one or more supervised machine learning algorithms as described further below. The labels may be reseller account labels or non-reseller account labels; however, in the illustrative embodiment, each label for the user behavior data 108 included in the initial training data set is a reseller account label, because the key user accounts identified by the predetermined labels 120 are all reseller accounts. After being added to the training data set, the key user accounts may be removed from the general population of remaining user accounts.

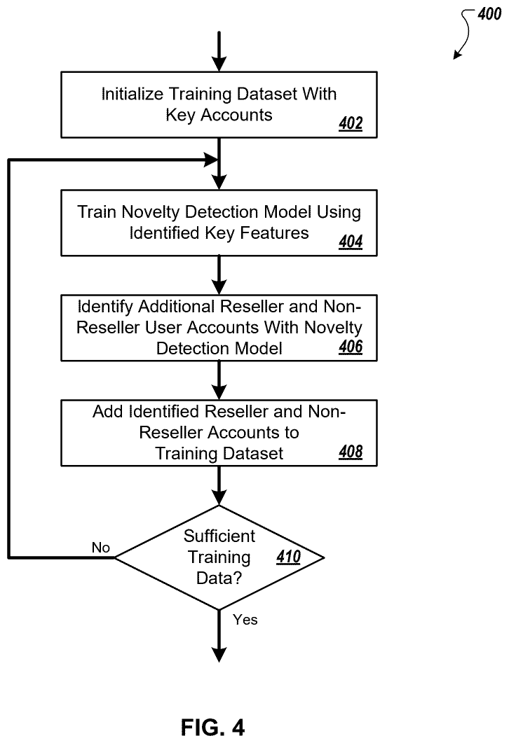

The account labeling system 102 further augments the training data set with additional user behavior data 108 associated with additional user accounts using a semi-supervised learning process. For example, the account labeling system 102 may use one or more unsupervised novelty detection algorithms, clustering algorithms, or other algorithms to identify user accounts that are similar to previously labeled user accounts, based on the associated user behavior data 108. Continuing that example, the account labeling system 102 may identify one or more clusters of user accounts similar to the key user accounts based on similarity of associated user behavior data accessed from the user profile data 110, the order history data 112, and/or the aggregate data 114. For those similar user accounts, the account labeling system 102 may add the associated user behavior data 108 to the training data set along with a reseller account label. As another example, the account labeling system 102 may identify user accounts that are not in the reseller cluster or are otherwise dissimilar to the key user accounts. For those dissimilar user accounts, the account labeling system 102 may add the associated user behavior data 108 to the training data set along with a non-reseller account label. The account labeling system 102 may continue to augment the training data set until one or more conditions are met. For example, the account labeling system 102 may continue augmenting the training data set until a certain number of accounts are represented in the training data set, until a certain proportion of reseller accounts and non-reseller accounts are represented in the training data set, or until another condition is satisfied. Thus, after augmentation the training data set includes user behavior data 108 and associated labels generated based on actual users of the retail system, and may not include synthetic training data. In the illustrative embodiment, after augmentation the training data set may include data for hundreds of thousands of user accounts (out of a total of at least 100 million user accounts). Additionally, in the illustrative embodiment, the training data set after augmentation may include data associated with roughly equal numbers of reseller accounts and non-reseller accounts (e.g., 250,000 reseller accounts and 250,000 non-reseller accounts). One potential embodiment of a method for generating the augmented training data set is described further below in connection with FIG. 4.

At 216, the account labeling system 102 trains one or more classification model(s) 116 using the training data set to classify a user account as a reseller account or a non-reseller account based on user behavior data 108. As described above, each of the account classifier model(s) 116 may be embodied as any machine learning classifier model, including gradient-boosted trees, an artificial neural network, a convolutional neural network, a support vector machine, and/or other classifier, and the account labeling system 102 may use any appropriate supervised machine learning algorithm to train the classifier model 116. In some embodiments, the account labeling system 102 may train a separate classification model 116 for each data source that provides user behavior data 108. For example, in the illustrative embodiment, the account labeling system 102 trains three classification models 116, and in particular trains a model for the profile data 110, a model for the order history data 112, and a model for the aggregate data 114. In some embodiments, the account labeling system 102 may rank the classification models based on accuracy at training time. After training the classifier model 116, the method 200 loops back to 202, in which the account labeling system 102 may continue to train the classification model(s) 116. For example, the account labeling system 102 may periodically retrain the classification model(s) 116 based on updated user behavior data 108. As another example, the account labeling system 102 may retrain the classification model(s) 116 on a predetermined schedule, on demand, and/or at different times.

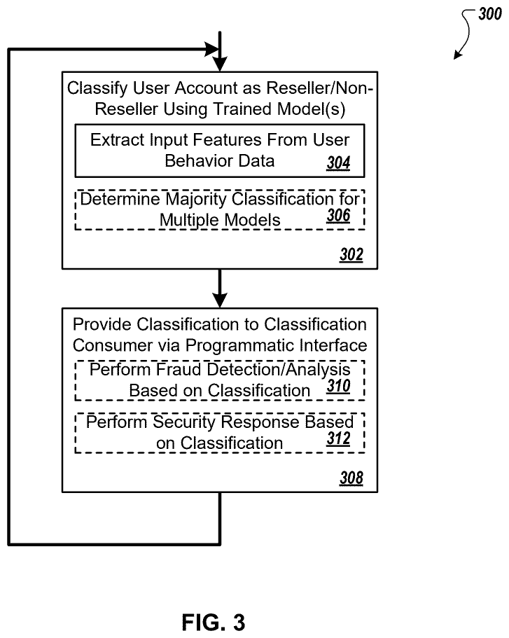

Referring now to FIG. 3, a flow diagram of an example method 300 is shown for providing a classification of a user account to a classification consumer using the trained classification model(s) 116. In the present example, the method 300 can be performed by components of the system 100 such as the account labeling system 102, and will be described with reference to FIG. 1. However, other systems may be used to perform the same or a similar process.

At 302, the account labeling system 102 classifies a user account as a reseller or non-reseller using one or more trained classification models 116. At 304, the account labeling system 102 extracts input features from one or more user behavior data 108 data sources. For example, the account labeling system 102 may select user behavior data 108 that matches the requested user account from the profile data 110, the order history data 112, and/or the aggregate data 114. In some embodiments, the account labeling system 102 may select historical user behavior data 108 for a user account, for example to help detect recent changes in behavior. At 306, in some embodiments the account labeling system 102 may determine a majority classification for multiple classification models 116. As described above, in some embodiments, the account labeling system 102 may train a classification model 116 for each of the data sources in use. Accordingly, the account classification system 102 may classify the user account using the trained classification model 116 for each of the data sources, and may select the final classification based on the classification provided by the majority of the models 116. For example, in the illustrative embodiment, the account labeling system 102 may select user behavior data 108 from the profile data 110, the order history data 112, and the aggregate data 114, and provide that selected data as input features to three respective classification models 116. Continuing that example, the account classification system 102 may determine the classification (e.g., as a reseller account versus a non-reseller account) based on the classification provided by at least two out of the three classification models 116. By performing classification with multiple trained classification models 116, the account labeling system 102 may provide improved classification for multiple stages of a customer journey in which different data sources or combinations of data may be available for that customer at different stages.

At 308, the account labeling system 102 provides the classification to a classification consumer such as a client system 106 via a programmatic interface. For example, the account labeling system 102 may provide one or more application programming interfaces (APIs) by which a client system 106 may request a classification for one or more user accounts. Each user account may be requested using a user identifier or other key associated with the user account. The account labeling system 102 may respond with the classification, which may be determined as described above in response to the API request. The classification consumer may use the classification for one or more security applications or other applications. For example, in an embodiment the returned classification may be used as training data to train a machine learning model for fraud detection or another security purpose. As another example, in an embodiment the returned classification may be used by a business application, for example to provide reseller-focused features or offers to reseller accounts. In some embodiments, the account labeling system 102 may periodically or otherwise determine the classification prior to receiving an API request and may retrieve the classification in response to the API request. For systems with large numbers of user accounts, it may be impractical to regularly classify each account, and thus in those embodiments the system 100 may classify a set of accounts of interest each day. For example, the automated classification may be performed daily on user accounts that are detected by one or more rules or are otherwise flagged as accounts of interest.

At 310, in some embodiments fraud detection and/or analysis may be performed based on the determined classification. For example, the client system 106 may perform fraud detection or analysis using the classification returned by the account labeling system 102. Continuing that example, one or more automated fraud detection systems or other systems may detect suspicious behavior associated with one or more user accounts. This suspicious behavior may include behavior that is associated with account takeover events in which a malicious actor gains unauthorized access to a user account and performs one or more fraudulent purchase or other malicious activity. However, as described above, this suspicious behavior may be similar to behavior associated with reseller accounts, which are not malicious. In response to the suspicious behavior, the client device 106 may submit an API request to the account labeling system 102 for the identified user account(s). The account labeling system 102 returns a response including a classification of each user account as a reseller account or a non-reseller account. Those user accounts that are identified as non-reseller accounts (e.g., based on past behavior) but associated with suspicious behavior may be the subject of an account takeover or other unauthorized access. Accordingly, the client device 106 may identify each of those accounts that are labeled as a non-reseller account as being subject to fraudulent or other malicious behavior, for example flagging that account for further analysis.

As another example, in an embodiment, the client device 106 may detect suspicious behavior including a large number of user accounts, such as a large number of automated logins. The client device 106 may request classification of those user accounts and compare the proportion of reseller accounts to non-reseller accounts. If the proportion of reseller accounts to non-reseller accounts is higher than expected (e.g., higher than a random sampling of user accounts or other measure of the expected proportion of reseller accounts for the retail system), then the suspicious behavior may be allowed. If the proportion of reseller accounts to non-reseller accounts is not higher than expected, then this indicates an account takeover event may be occurring.

At 312, in some embodiments a security response may be performed based on the classification. For example, in some embodiments the user account system 104 or other system may change a security policy for a user account, lock a user account, reset a user account password, or perform other security response based on the classification provided by the account labeling system 102. After providing the classification, the method 300 loops back to 302 to continue classifying user accounts and providing classifications to classification consumers.

Referring now to FIG. 4, a flow diagram of an example method 400 is shown for augmenting the training data set for training the classification model(s) 116. As described above, in some embodiments the method 400 may be executed in connection with block 214 shown in FIG. 2. In the present example, the method 400 can be performed by components of the system 100 such as the account labeling system 102, and will be described with reference to FIG. 1. However, other systems may be used to perform the same or a similar process.

At 402, the account labeling system 102 initializes the training data set with data from the user data associated with the predetermined key user accounts. As described above, the account labeling system 102 may select user behavior data 108 associated with the key user accounts from one or more data sources, including the user profile data 110, the order history data 112, and/or the aggregate data 114. The training data set also includes labels that may be used for training with one or more supervised machine learning algorithms as described further below. The labels may be reseller account labels or non-reseller account labels; however, in the illustrative embodiment, each label for the user behavior data 108 included in the initial training data set is a reseller account label, because the key user accounts identified by the predetermined labels 120 are all reseller accounts. After being added to the training data set, the key user accounts may be removed from the general population of remaining user accounts.

At 404, the account labeling system 102 trains a novelty detection model using identified key features of the user accounts included in the training data set. The novelty detection model may be embodied as any semi-supervised or unsupervised model capable of determining whether an additional user account is a member of the reseller class of user accounts. For example, in an illustrative embodiment the novelty detection model is an isolation forest; in other embodiments, the novelty detection model may be embodied as a one-SVM classifier, a clustering algorithm, or other novelty detection model.

At 406, the account labeling system 102 identifies one or more additional user accounts from the general population of user accounts (i.e., from those user accounts not already included in the training data set) as reseller accounts and/or non-reseller accounts using the novelty detection model. For example, in an illustrative embodiment one or more user accounts may be sampled from the general population and input to the isolation forest. The isolation forest may output a score that indicates whether an input user account is likely a reseller account or a non-reseller account (e.g., the user account is an outlier or otherwise novel and thus not included in the reseller accounts).

At 408, the account labeling system 102 adds the identified reseller and non-reseller user accounts to the training data set with an associated label (e.g., reseller or non-reseller account labels as described above). Accounts that are added to the training data set may be removed from the general population of user accounts. By adding the user accounts to the training data set, the account labeling system 102 augments the training data set.

At 410, the account labeling system 102 determines whether a sufficient amount of training data has been added to the augmented training data set. For example, the account labeling system 102 may determine whether a certain number of accounts are represented in the training data set, whether a certain proportion of reseller accounts and non-reseller accounts are represented in the training data set, or whether another condition is satisfied. For example, in an embodiment having at least 100 million total user accounts, the account labeling system 102 may determine whether the training data set includes data from at least 500,000 user accounts. Additionally or alternatively, the account labeling system 102 may determine whether the training data set includes data from at least 250,000 reseller accounts together with data from at least 250,000 non-reseller accounts. As another example, the account labeling system 102 may determine whether the training data set has data from a similar proportion of reseller and non-reseller accounts as the overall data set. Continuing that example, the account labeling system 102 may determine whether the training data set includes at least 10% of data from reseller accounts, which may be similar to the proportion of overall user accounts. Referring again to 410, if the account labeling system 102 determines that sufficient training data as not yet been added to the training data set, the method 400 loops back to 404, in which the novelty detection model may be updated based on the training data set and then additional training data augmentation may be performed. Referring again to 410, if the account labeling system 102 determines that sufficient training data has been added to the training data set, the method 400 may be completed. As described above, after augmenting the training data set, the account classifier model(s) 116 may be trained using the augmented training data set.

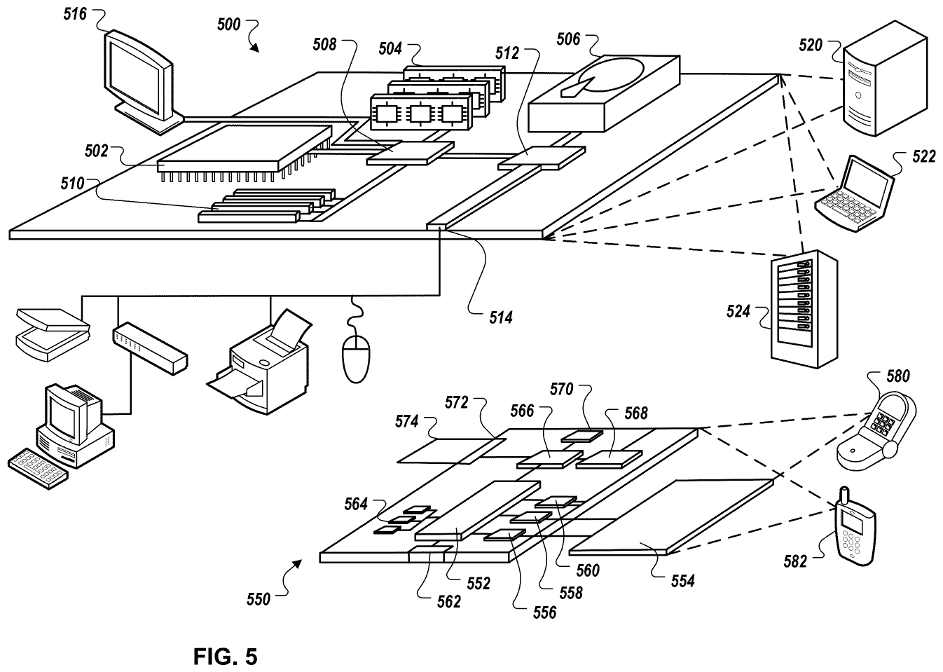

FIG. 5 shows an example of a computing device 500 and an example of a mobile computing device 550 that can be used to implement the techniques described here. The computing device 500 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and can be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 504 stores information within the computing device 500. In some implementations, the memory 504 is a volatile memory unit or units. In some implementations, the memory 504 is a non-volatile memory unit or units. The memory 504 can also be another form of computer-readable medium, such as a magnetic or optical disk.

The storage device 506 is capable of providing mass storage for the computing device 500. In some implementations, the storage device 506 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer-or machine-readable medium, such as the memory 504, the storage device 506, or memory on the processor 502.

The high-speed interface 508 manages bandwidth-intensive operations for the computing device 500, while the low-speed interface 512 manages lower bandwidth-intensive operations. Such allocation of functions is exemplary only. In some implementations, the high-speed interface 508 is coupled to the memory 504, the display 516 (e.g., through a graphics processor or accelerator), and to the high-speed expansion ports 510, which can accept various expansion cards (not shown). In the implementation, the low-speed interface 512 is coupled to the storage device 506 and the low-speed expansion port 514. The low-speed expansion port 514, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 500 can be implemented in a number of different forms, as shown in the figure. For example, it can be implemented as a standard server 520, or multiple times in a group of such servers. In addition, it can be implemented in a personal computer such as a laptop computer 522. It can also be implemented as part of a rack server system 524. Alternatively, components from the computing device 500 can be combined with other components in a mobile device (not shown), such as a mobile computing device 550. Each of such devices can contain one or more of the computing device 500 and the mobile computing device 550, and an entire system can be made up of multiple computing devices communicating with each other.

The mobile computing device 550 includes a processor 552, a memory 564, an input/output device such as a display 554, a communication interface 566, and a transceiver 568, among other components. The mobile computing device 550 can also be provided with a storage device, such as a micro-drive or other device, to provide additional storage. Each of the processor 552, the memory 564, the display 554, the communication interface 566, and the transceiver 568, are interconnected using various buses, and several of the components can be mounted on a common motherboard or in other manners as appropriate.

The processor 552 can execute instructions within the mobile computing device 550, including instructions stored in the memory 564. The processor 552 can be implemented as a chipset of chips that include separate and multiple analog and digital processors. The processor 552 can provide, for example, for coordination of the other components of the mobile computing device 550, such as control of user interfaces, applications run by the mobile computing device 550, and wireless communication by the mobile computing device 550.

The processor 552 can communicate with a user through a control interface 558 and a display interface 556 coupled to the display 554. The display 554 can be, for example, a TFT (Thin-Film-Transistor Liquid Crystal Display) display or an OLED (Organic Light Emitting Diode) display, or other appropriate display technology. The display interface 556 can comprise appropriate circuitry for driving the display 554 to present graphical and other information to a user. The control interface 558 can receive commands from a user and convert them for submission to the processor 552. In addition, an external interface 562 can provide communication with the processor 552, so as to enable near area communication of the mobile computing device 550 with other devices. The external interface 562 can provide, for example, for wired communication in some implementations, or for wireless communication in other implementations, and multiple interfaces can also be used.

The memory 564 stores information within the mobile computing device 550. The memory 564 can be implemented as one or more of a computer-readable medium or media, a volatile memory unit or units, or a non-volatile memory unit or units. An expansion memory 574 can also be provided and connected to the mobile computing device 550 through an expansion interface 572, which can include, for example, a SIMM (Single In Line Memory Module) card interface. The expansion memory 574 can provide extra storage space for the mobile computing device 550, or can also store applications or other information for the mobile computing device 550. Specifically, the expansion memory 574 can include instructions to carry out or supplement the processes described above, and can include secure information also. Thus, for example, the expansion memory 574 can be provide as a security module for the mobile computing device 550, and can be programmed with instructions that permit secure use of the mobile computing device 550. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer-or machine-readable medium, such as the memory 564, the expansion memory 574, or memory on the processor 552. In some implementations, the computer program product can be received in a propagated signal, for example, over the transceiver 568 or the external interface 562.

The mobile computing device 550 can communicate wirelessly through the communication interface 566, which can include digital signal processing circuitry where necessary. The communication interface 566 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 568 using a radio-frequency. In addition, short-range communication can occur, such as using a Bluetooth, WiFi, or other such transceiver (not shown). In addition, a GPS (Global Positioning System) receiver module 570 can provide additional navigation-and location-related wireless data to the mobile computing device 550, which can be used as appropriate by applications running on the mobile computing device 550.

The mobile computing device 550 can also communicate audibly using an audio codec 560, which can receive spoken information from a user and convert it to usable digital information. The audio codec 560 can likewise generate audible sound for a user, such as through a speaker, e.g., in a handset of the mobile computing device 550. Such sound can include sound from voice telephone calls, can include recorded sound (e.g., voice messages, music files, etc.) and can also include sound generated by applications operating on the mobile computing device 550.

The mobile computing device 550 can be implemented in a number of different forms, as shown in the figure. For example, it can be implemented as a cellular telephone 580. It can also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A computer-implemented method for classifying user accounts, the method comprising:
receiving a plurality of predetermined user account labels, wherein each user account label is associated with a user account of a plurality of user accounts for a retail system, wherein each user account is associated with user behavior data of a data source for the retail system, and wherein each of the user account labels is indicative of a reseller account label;
selecting a training data set including user behavior data from the data source associated with the predetermined user account labels;
augmenting the training data set with additional user behavior data from the data source, wherein the additional user behavior data is associated with one or more additional user accounts for the retail system, and wherein the additional user behavior data is associated with a reseller account label or a non-reseller account label; and
training a classification model with the training data set in response to augmenting the training data, wherein the classification model is trained to classify a first user account for the retail system with a reseller account label or a non-reseller account label based on user behavior data of the data source associated with the first user account.

2. The method of claim 1, wherein:
selecting the training data set comprises selecting the user behavior data from a plurality of data sources for the retail system; and
training the classification model comprises training a plurality of classification models, wherein each classification model of the plurality of classification models is associated with a data source of the plurality of data sources.

3. The method of claim 2, wherein the plurality of data sources comprises a user profile data source, an order history data source, and an aggregated item data source.

4. The method of claim 1, wherein the user behavior data comprises user name, user email address, account open date, count of associated user devices, count of shipping addresses, count of payment cards, order history, or item combination.

5. The method of claim 1, wherein augmenting the training data set comprises identifying a cluster of user accounts for the retail system with an unsupervised clustering algorithm based on the user behavior data, wherein the cluster of user accounts includes the user accounts associated with the predetermined user account labels.

6. The method of claim 1, wherein training the classification model comprises training the classification model with a supervised machine learning algorithm.

7. The method of claim 1, further comprising classifying, in response to training the classification model, the first user account with a reseller account label or a non-reseller account label using the classification model based on the user behavior data of the data source associated with the first user account.

8. The method of claim 7, further comprising:
receiving a request for classification of the first user account from a client system; and
sending a response including a classification of the first user account to the client system in response to receiving the request and in response to classifying the first user account, wherein the classification comprises the reseller account label or the non-reseller account label.

9. The method of claim 7, wherein classifying the first user account further comprises:
classifying the first user account with a plurality of classification models, wherein each classification model is associated with a data source of a plurality of data sources for the retail system; and
selecting the classification based on a majority of the plurality of classification models.

10. The method of claim 7, further comprising performing fraud detection based on the classification of the first user account.

11. A computer system comprising:
one or more data processing apparatuses including one or more processors, memory, and storage devices storing instructions that, when executed, cause the one or more processors to perform operations comprising:
receiving a plurality of predetermined user account labels, wherein each user account label is associated with a user account of a plurality of user accounts for a retail system, wherein each user account is associated with user behavior data of a data source for the retail system, and wherein each of the user account labels is indicative of a reseller account label;
selecting a training data set including user behavior data from the data source associated with the predetermined user account labels;
augmenting the training data set with additional user behavior data from the data source, wherein the additional user behavior data is associated with one or more additional user accounts for the retail system, and wherein the additional user behavior data is associated with a reseller account label or a non-reseller account label; and
training a classification model with the training data set in response to augmenting the training data, wherein the classification model is trained to classify a first user account for the retail system with a reseller account label or a non-reseller account label based on user behavior data of the data source associated with the first user account.

12. The computer system of claim 11, wherein:
selecting the training data set comprises selecting the user behavior data from a plurality of data sources for the retail system; and
training the classification model comprises training a plurality of classification models, wherein each classification model of the plurality of classification models is associated with a data source of the plurality of data sources.

13. The computer system of claim 11, wherein augmenting the training data set comprises identifying a cluster of user accounts for the retail system with an unsupervised clustering algorithm based on the user behavior data, wherein the cluster of user accounts includes the user accounts associated with the predetermined user account labels.

14. The computer system of claim 11, wherein training the classification model comprises training the classification model with a supervised machine learning algorithm.

15. The computer system of claim 11, the operations further comprising classifying, in response to training the classification model, the first user account with a reseller account label or a non-reseller account label using the classification model based on the user behavior data of the data source associated with the first user account.

16. The computer system of claim 15, wherein classifying the first user account further comprises:
classifying the first user account with a plurality of classification models, wherein each classification model is associated with a data source of a plurality of data sources for the retail system; and
selecting the classification based on a majority of the plurality of classification models.

17. The computer system of claim 15, the operations further comprising performing fraud detection based on the classification of the first user account.

18. A non-transitory computer-readable storage medium coupled to one or more processors and having instructions stored thereon which, when executed by the one or more processors, cause the one or more processors to perform operations comprising:
receiving a plurality of predetermined user account labels, wherein each user account label is associated with a user account of a plurality of user accounts for a retail system, wherein each user account is associated with user behavior data of a data source for the retail system, and wherein each of the user account labels is indicative of a reseller account label;
selecting a training data set including user behavior data from the data source associated with the predetermined user account labels;
augmenting the training data set with additional user behavior data from the data source, wherein the additional user behavior data is associated with one or more additional user accounts for the retail system, and wherein the additional user behavior data is associated with a reseller account label or a non-reseller account label; and
training a classification model with the training data set in response to augmenting the training data, wherein the classification model is trained to classify a first user account for the retail system with a reseller account label or a non-reseller account label based on user behavior data of the data source associated with the first user account.

19. The non-transitory computer-readable storage medium of claim 18, wherein:
selecting the training data set comprises selecting the user behavior data from a plurality of data sources for the retail system; and
training the classification model comprises training a plurality of classification models, wherein each classification model of the plurality of classification models is associated with a data source of the plurality of data sources.

20. The non-transitory computer-readable storage medium of claim 18, the operations further comprising classifying, in response to training the classification model, the first user account with a reseller account label or a non-reseller account label using the classification model based on the user behavior data of the data source associated with the first user account.
